(19) United States
(12) Patent Application Publication
(10) Pub. No.: US 2021/0383347 A1
(43) Pub. Date: Dec. 9, 2021

(54) CO-PROCESSING UNITS BASED FISCAL CONTROL UNIT

(71) Applicant: Intel Corporation, Santa Clara, CA (US)

(72) Inventor: Stephen AHERN, Sixmilebridge (IE)

(21) Appl. No.: 16/322,876

(22) PCT Filed: Sep. 30, 2016
(86) PCT No.: PCT/US2016/055000

§ 371 Date: Feb. 1, 2019

(51) Int. Cl. G06Q 20/20; G06Q 20/40

(52) U.S. Cl. CPC G06Q 20/206; G06Q 20/401; G06Q 20/202

(57) ABSTRACT

A fiscal control unit system may include a central processor unit that includes a first processing unit and a second processing unit that operates independently of the first processing unit, and isolated from the first processing unit. A buffer module may operate within the first processing unit to provide communication with a fiscal control server and an electronic transaction register and wherein the buffer module may receive transaction registrations from the electronic transaction register. A signing module may operate within the second processing unit, to communicate with the buffer module, and to provide a cryptographic record of transaction registrations received by the buffer module.

### TECHNICAL FIELD

The present disclosure relates to technology associated with fiscal control units, including those used for collection of sales tax revenues, and in particular, to apparatuses, methods and storage media associated with a co-processing units based fiscal control unit.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Fiscal control units (FCUs), sometimes referred to as fiscal compliance managers, are devices that may be connected to electronic cash registers and/or other point-of-sale (PoS) systems to provide tamper-proof or tamper-resistant recording of retail transactions to facilitate collection of sales tax revenues and/or other taxes or governmental or agency fees based on retail and/or consumer transactions. As described herein, sales tax and/or other taxes or governmental or agency fees based on retail and/or consumer transactions may be referred to as “sales taxes,” and retail and/or consumer transactions may be referred to as “retail transactions.” As examples, FCUs may be used in retail and/or hospitality business sectors in a wide range of environments that may include in-person transactions, taxi businesses, fuel pumps, vending and ticketing machines, as well as any other type of retail transaction or mechanism. Moreover, in addition to retail transactions, aspects of such fiscal control units may have application in a wider range of applications in which establishing and/or authenticating any type of record with antitamper protection may be desired such as, for example medical records, footfall in a leased building (e.g., public museum for estimating rents), etc.

Electronic cash registers and/or other point-of-sale (PoS) systems for which FCUs may be used and/or required may be referred to generally as electronic transaction registers. In some jurisdictions, FCUs may be required to be connected to electronic transaction registers to use the electronic transaction registers in retail transactions and/or transactions of market traders. Increasingly, mobile transaction devices such as mobile or tablet computers and/or smart mobile telephones may be used as mobile POS (M-PoS) systems in retail transactions In some situations, coupling FCUs to M-PoS systems may be inconvenient and/or impractical.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of a fiscal control unit (FCU) apparatus or system according to some embodiments.

FIG. 2 schematically illustrates a computing device which, in accordance with some embodiments, may provide an operating environment for the FCU of FIG. 1.

FIG. 3 is a block diagram illustrating an example embodiment of an operating environment of primary processing unit and secondary processing unit of a CPU platform, for example.

FIG. 4 is a flow diagram illustrating an example a process, according to some embodiments.

FIG. 5 is a flowchart illustrating an example a process of FCU operation, according to some embodiments.

FIG. 6 is a block diagram of an anti-tamper apparatus or system according to some embodiments.

FIG. 7 illustrates an example computer-readable non-transitory storage medium that may be suitable for use to store instructions, according to some embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Also, it is noted that example embodiments may be described as a process depicted with a flowchart, a flow diagram, a data flow diagram, a structure diagram, or a block diagram. Although a flowchart may describe the operations as a sequential process, many of the operations may be performed in parallel, concurrently, or simultaneously. In addition, the order of the operations may be re-arranged. A process may be terminated when its operations are completed, but may also have additional steps not included in a figure. A process may correspond to a method, a function, a procedure, a subroutine, a subprogram, and the like. When a process corresponds to a function, its termination may correspond to a return of the function to the calling function a main function.

As disclosed herein, the term “memory” may represent one or more hardware devices for storing data, including random access memory (RAM), magnetic RAM, core memory, read only memory (ROM), magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium. A code segment may represent a procedure, a function, a subprogram, a program, a routine, a subroutine, a module, program code, a software package, a class, or any combination of instructions, data structures, program statements, and the like.

As used herein, the term “network element”, may be considered synonymous to or referred to as a networked computer, networking hardware, network equipment, router, switch, hub, bridge, gateway, or other like device. The term “network element” may describe a physical computing device of a network with wired or wireless communication links. Furthermore, the term “network element” may describe equipment that provides radio baseband functions for data or voice connectivity between a network and one or more users.

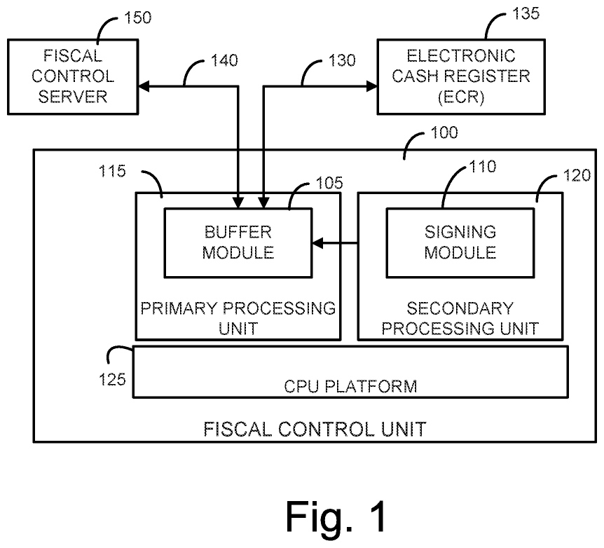

FIG. 1 is a block diagram of a fiscal control unit (FCU) apparatus or system 100 according to some embodiments, which may also be referred to as a fiscal compliance manager or a sales recording device. FCU system 100 may include a buffer module 105 and a signing module 110, which may operate on, respectively, a first or primary processing unit 115 and an independent second or secondary processing unit 120 of a central processor unit 125. Accordingly, FCU system 100 may be referred to as a co-processing units based fiscal control unit. Primary processing unit 115 and secondary processing unit 120 are independent of each other in that in that secondary processing unit 120 may be isolated and protected with respect to first processing unit 115, and may operate independently of an operating system controlling first processing unit 115. Therefore, the operations and data of buffer module 105 and signing module 110 may be respectively secured from each other. That is, in the event buffer module 105 is compromised, the security and integrity of signing module 110 is not affected, and vice versa.

In embodiments, buffer module 105 may provide communication over a communication pathway 130 with an electronic transaction register 135, which may include and/or be referred to as an electronic cash register (ECR) 135. ECR 135 may be local to FCU system 100, and communication pathway 130 may be a wired or wireless localized communication format such as, for example, a wired USB or other format or a wireless format such as Bluetooth. ECR 135 may be used in connection with retail and/or consumer transactions, which separately and/or together may be referred to as “retail transactions,” to record and/or register such retail transactions. As examples, FCU system 100 and ECR 135 may be used in retail and/or hospitality business sectors in a wide range of environments that may include in-person transactions, taxi businesses, fuel pumps, vending and ticketing machines, as well as any other type of retail transaction or mechanism.

Buffer module 105 may also provide communication over a network 140 with a fiscal control server 150, which may be operated by or on behalf of a governmental or other taxing authority or agency to receive from FCU system 100 information relating to retail transactions that may be recorded or registered by ECR 135. The information that the fiscal control server 150 may receive via buffer module 105 of FCU system 100 may be to facilitate collection of sales tax revenues and/or other taxes or fees based on retail transactions. As described herein, sales tax and/or other taxes or governmental or agency fees based on retail transactions may be referred to as “sales taxes.” Network 140 may be or include a public and/or a private wide area network and may include the Internet and or an intranet.

Signing module 110 may communicate with buffer module 105 to receive information relating to retail transactions that may be recorded or registered by ECR 135 and to provide encryption of the retail transaction information to provide a cryptographic record of such transaction registrations. Signing module 110 may further provide to buffer module 105 cryptographic receipt information for a transaction registration, and buffer module 105 may provide the cryptographic receipt information to ECR 135 to be included in a printed receipt, which may be provided to a retail customer. In embodiments, FCU system 100 may be directed to providing tamper-proof or tamper-resistant recording of retail transactions.

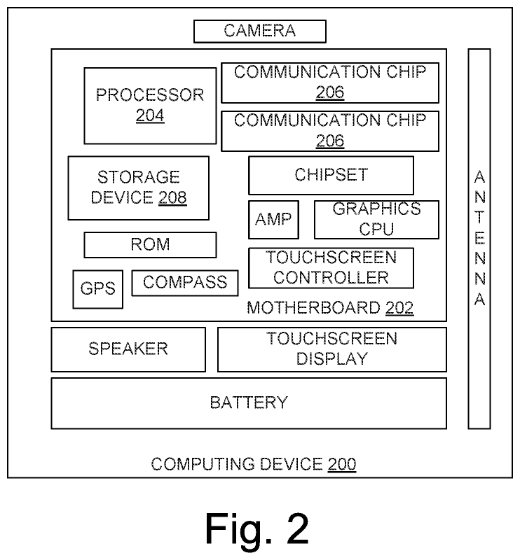

FIG. 2 schematically illustrates a computing device 200 which, in accordance with some embodiments, may provide an operating environment for FCU 100.

The computing device 200 may be, for example, a mobile communication device or a desktop or rack-based computing device. The computing device 200 may house a board such as a motherboard 202. The motherboard 202 may include a number of components, including (but not limited to) a processor 204 and at least one communication chip 206. Any of the components discussed herein with reference to the computing device 200 may be arranged in or coupled with a package such as discussed herein. In further implementations, the communication chip 206 may be part of the processor 204. In embodiments, processor 204 may correspond to and/or operate as central processor unit 125 and may include first processing unit 115 and independent second processing unit 120.

The computing device 200 may include a storage device 208. In some embodiments, the storage device 208 may include one or more solid state drives. Examples of storage devices that may be included in the storage device 208 include volatile memory (e.g., dynamic random access memory (DRAM)), non-volatile memory (e.g., read-only memory, ROM), flash memory, and mass storage devices (such as hard disk drives, compact discs (CDs), digital versatile discs (DVDs), and so forth).

Depending on its applications, the computing device 200 may include other components that may or may not be physically and electrically coupled to the motherboard 202. These other components may include, but are not limited to, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, a Geiger counter, an accelerometer, a gyroscope, a speaker, and a camera.

The communication chip 206 and the antenna may enable wireless communications for the transfer of data to and from the computing device 200. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 206 may implement any of a number of wireless standards or protocols, including but not limited to Institute for Electrical and Electronic Engineers (IEEE) standards including Wi-Fi (IEEE 202.11 family), IEEE 202.16 standards (e.g., IEEE 202.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 202.16 compatible broadband wide region (BWA) networks are generally referred to as WiMAX networks, an acronym that stands for Worldwide Interoperability for Microwave Access, which is a certification mark for products that pass conformity and interoperability tests for the IEEE 202.16 standards. The communication chip 206 may operate in accordance with a Global System for Mobile Communications (GSM), General Packet Radio Service (GPRS), Universal Mobile Telecommunications System (UMTS), High Speed Packet Access (HSPA), Evolved HSPA (E-HSPA), or LTE network. The communication chip 206 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 206 may operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication chip 206 may operate in accordance with other wireless protocols in other embodiments.

The computing device 200 may include a plurality of communication chips 206. For instance, a first communication chip 206 may be dedicated to shorter range wireless communications such as Wi-Fi and Bluetooth, and a second communication chip 206 may be dedicated to longer range wireless communications such as GPS, EDGE, GPRS, CDMA, WiMAX, LTE, EV-DO, and others. In some embodiments, the communication chip 206 may support wired communications. For example, the computing device 200 may include one or more wired servers.

The processor 204 and/or the communication chip 206 of the computing device 200 may include one or more dies or other components in an IC package. Such an IC package may be coupled with an interposer or another package using any of the techniques disclosed herein. The term “processor” may refer to any device or portion of a device that processes electronic data from registers and/or memory to transform that electronic data into other electronic data that may be stored in registers and/or memory.

In various implementations, the computing device 200 may be a laptop, a netbook, a notebook, an ultrabook, a smartphone, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, the computing device 200 may be any other electronic device that processes data.

In some embodiments, in which processor 204 may correspond to and/or operate as central processor unit 125 and may include first processing unit 115 and independent second processing unit 120 having the separation and security features as earlier described. First processing unit 115 may operate as a primary processing unit of the central processor unit 125 and may provide generalized primary processing provided by the central processor unit 125 and/or processor 204 in accordance with an overall operating system. The second processing unit 120 may be an embedded, isolated, and protected secondary co-processing unit, with respect to first processing unit 115, and may operate independently of the overall operating system. In embodiments, secondary processing unit 120 may operate as a management engine (ME) of a platform controller hub (PCH) of processor 204 and may be implemented in connection with Intel® Active Management Technology, which may be incorporated into some central processing and/or central processor units available from Intel Corporation, for example. In alternate embodiments, first processing unit 115 and secondary processing unit 120 may be respectively disposed in two separate and/or isolated processor cores of a multi-core microprocessor. In still other alternate embodiments, first processing unit 115 and second processing unit 120 may correspond to respective virtual machines that may operate within one or more processor cores with independent and/or separate operation.

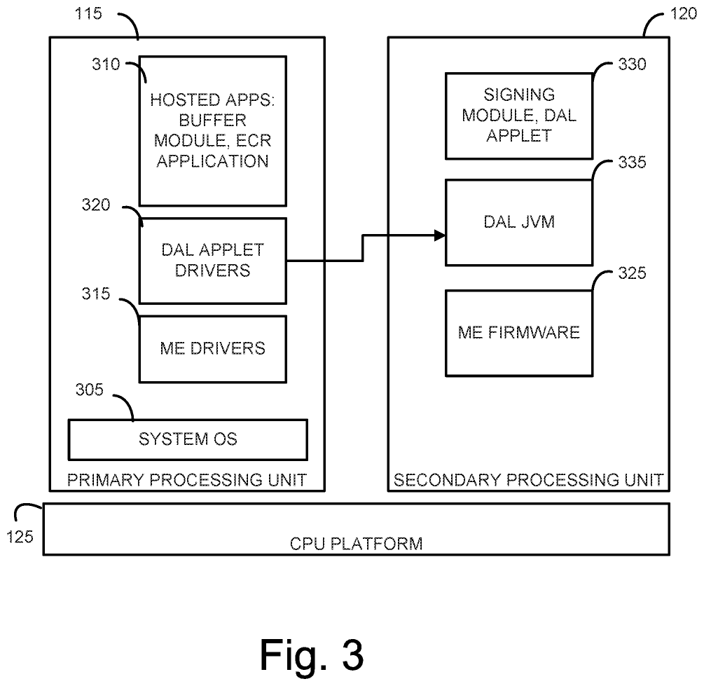

FIG. 3 is a block diagram illustrating an example embodiment of an operating environment of primary processing unit 115 and an independent secondary processing unit 120 of a CPU platform 125, for example.

In embodiments, primary processing unit 115 may operate in connection with a system OS 305, which may control overall operation of a device such as computing device 200. Primary processing unit 115 may host and/or execute one or more hosted applications 310, which may include an application for buffer module 105. Buffer module 105 may communicate with an ECR 135, which may be separate and distinct from CPU platform 135 as illustrated in FIG. 1, for example. In other embodiments, hosted applications 310 may further include an ECR application that may operate within primary processing unit 115 in substitution for separate and distinct ECR 135. Primary processing unit 115 may further host and/or execute ME drivers 315 and dynamic application loader (DAL) drivers 320 that may relate to independent operation of secondary processing unit 120 relative to primary processing unit 115.

Secondary processing unit 120 may operate independently of system OS 305, such as in connection with ME firmware 325, which may sometimes be referred to as security domain and/or security engine firmware and may include a real-time operating system separate from system OS 305. Secondary processing unit 120 may further host and/or execute one or more DAL applications 330, which may include a DAL application 330 for signing module 110. In embodiments, DAL applications 330 may be executed by or within a Java virtual machine (JVM) 335. In embodiments, DAL application 330 for signing module 110 may be executed with isolation by JVM 335. In other embodiments, JVM 335 may execute only DAL application 330 that have proper security authorization, thereby increasing the security of operation signing module 110.

As a result, the execution environment of secondary processing unit 120 may be separate from primary processing unit 115 and OS 305, and further may not share memory space with the OS 305. The hosted applications 310 may interact with the DAL JVM 335 via various APIs. In embodiments, the OS 305 may see the DAL JVM 335 as a separate hardware peripheral that may be connected via a bus and my require host software and/or device drivers to access. In some embodiments, the DAL JVM 335 may provide applets with a protected real time clock, DRNG, monotonic counters, AES/DES/RSA/SHA/HMAC accelerators, sealing keys, and up to 255 bytes of NVRAM storage.

Moreover, in some embodiments, second processing unit 120 may include MAC and/or IP addresses that may be separate from MAC and/or IP addresses of first processing unit 115 and so that second processing unit 120 may have direct access to and/or communication via communication chip 206 separate from and independent of first processing unit 115.

As a result, a secure data communication path can be created according to ME firmware 325 between secondary processing unit 120 and fiscal control server 150 and/or a manufacturer of FCU 100 purposes of initial provisioning and secure key injection when FCU 100 is first connected to network 140. Similarly, such an independent and secure data communication path from secondary processing unit 120 to fiscal control server 150, separate from primary processing unit 115, may provide for secure uploading of transaction information by buffer module 105 to fiscal control server 150. Moreover, the governmental entity (or any other appropriate entity depending on the area of application) operating fiscal control server 150, or on behalf of whom fiscal control server 150 is operated, may revoke older keys encryption and/or inject new signature keys.

The isolated, independent, and protected operation of secondary processing unit 120 with respect to first processing unit 115 may provide operation of signing module 110 that is sufficiently distinct and separate from operation of buffer module 105 and primary processing unit 115 to meet regulatory requirements relating to required isolation between signing and buffering in fiscal control units. Secondary processing unit 120 may provide a secure, isolated execution environment for signing module 110, as required by some regulatory and/or taxing agencies. As a result, fiscal control unit 100, as may be operated in connection with a CPU platform that may include a primary processing unit 115 and an independent secondary processing unit 120, may provide mobile POS (M-PoS) systems, or other POS systems, with a secure fiscal control unit that does not require additional separate hardware components, that has little or no impact on M-PoS power requirements and/or battery life, and/or no changes in M-PoS form factors.

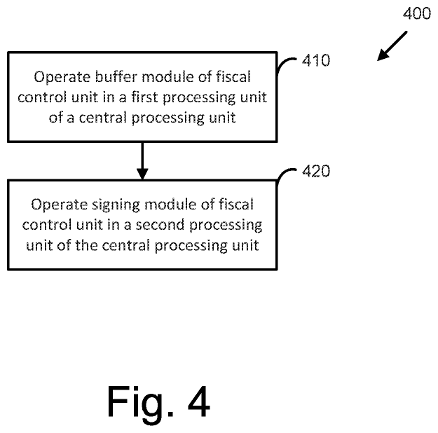

FIG. 4 is a flow diagram illustrating an example process 400, according to some embodiments.

At operation 410, a buffer module of a fiscal control unit may be operated in a first processing unit of a central processor unit. In embodiments, the buffer module may communicate with an electronic transaction register (e.g., an ECR) to receive transaction registrations from the electronic transaction register.

At operation 420, a signing module of the fiscal control unit may be operated within a second processing unit of the central processor unit, wherein the second processing unit may operate independently of the first processing unit and the signing module is to communicate with the buffer module to provide a cryptographic record of transaction registrations received by the buffer module.

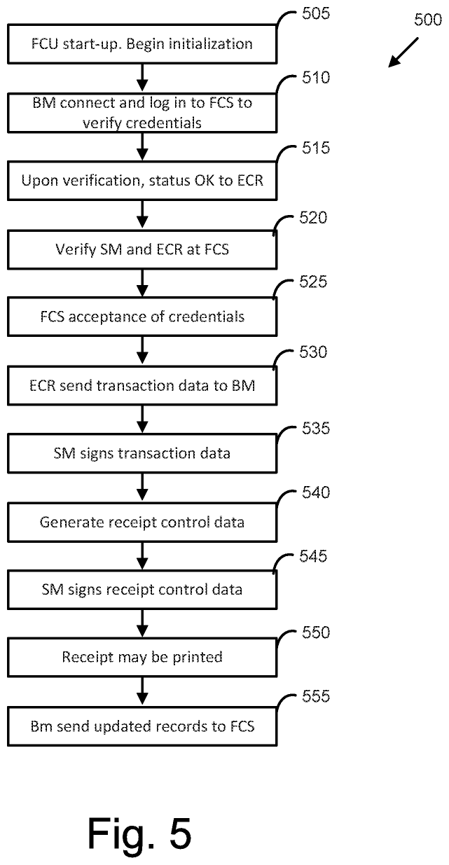

FIG. 5 is a flowchart illustrating an example a process 500 of FCU operation, according to some embodiments. The FCU operation may be with regard to, for example, FCU 100 in which buffer module 105 may operate within a primary processing unit 115 of CPU platform 125, and signing module 110 may operate within secondary processing unit 120 of CPU platform 125, wherein processing unit 120 operates independent of processing unit 115.

At operation 505, FCU may start-up and begin initialization.

At operation 510, the buffer module (BM) may connect and log in to the fiscal control server (FCS) to verify the fiscal control server credentials.

At operation 515, upon verification of credentials and completing initialization, the buffer module may send a status OK signal to the connected ECR.

At operation 520, the buffer module may verify with the fiscal control server the signing module (SM) and the ECR. In embodiments, this verification may include the fiscal control server sending one or more challenges and/or queries and the buffer module sending to the fiscal control server one or more responses, which may include one or more cryptographic credentials.

At operation 525, the buffer module may receive from the fiscal control server acceptance of the responses, which may include one or more cryptographic credentials.

At operation 530, the ECR sends transaction data to the buffer module.

At operation 535, the signing module cryptographically signs (e.g., encrypts) the transaction data and the transaction data may be stored. In embodiments, cryptographically signed and/or encrypted transaction data, which may include a receipt, signature, and various current transaction counters, may be stored in the buffer module.

At operation 540, receipt control data may be generated. In embodiments, receipt control data may be generated by the buffer module and may include ECR model information, transaction date and time, and/or sales total, etc.

At operation 545, receipt control data may be sent to the signing module for cryptographic signature. In embodiments, sales amount of the cash register receipts may be updated at a sum counter, which may be held by the buffer module. The receipt control data may include ECR model, transaction date and time, and/or sales total, etc.

At operation 550, the buffer module may notify the ECR that the receipt can be printed, whereby the receipt including any control information may be printed by the ECR.

At operation 555, the buffer module may send updated records to the fiscal control server when it requests them.

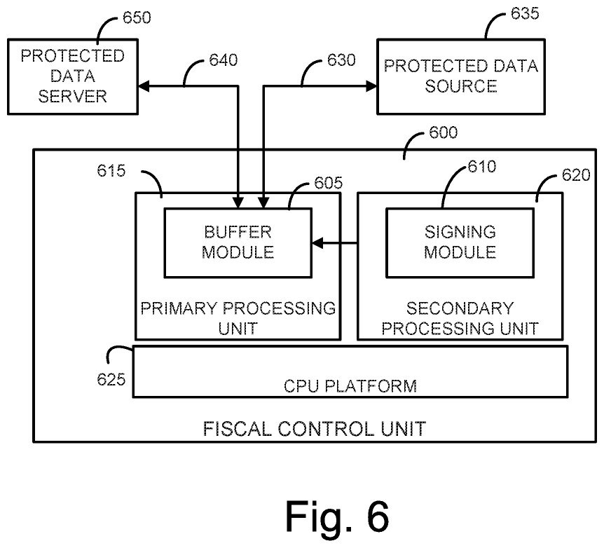

FIG. 6 is a block diagram of an anti-tamper apparatus or system 600, which according to some embodiments may be implemented as FCU 100, and in other embodiments may be implemented to provide anti-tampering protection of protected data other than data relating to fiscal or retail transactions. As examples, anti-tamper system 600 may be directed to preventing tampering with data that may relate to medical or other personal records or information, billing invoices, or any other proprietary or classified information that may be held and/or used by a business, governmental, or some other type of entity. Anti-tamper system 600 may include a buffer module 605 and a signing module 610, which may operate on, respectively, a first or primary processing unit 615 and an independent second or secondary processing unit 620 of a central processor unit 625. Accordingly, anti-tamper system 600 may be referred to as a co-processing units based anti-tamper system. Primary processing unit 615 and secondary processing unit 620 are independent of each other in that in that secondary processing unit 620 may be isolated and protected with respect to first processing unit 615, and may operate independently of an operating system controlling first processing unit 615. Therefore, the operations and data of buffer module 605 and signing module 610 may be respectively secured from each other. That is, in the event buffer module 605 is compromised, the security and integrity of signing module 610 is not affected, and vice versa.

In embodiments, buffer module 605 may provide communication over a communication pathway 630 with a source 635 of protected data, which may be referred to as a protected data source 635. Protected data source 635 may be local to anti-tamper system 600, and communication pathway 630 may be a wired or wireless localized communication format such as, for example, a wired USB or other format or a wireless format such as Bluetooth. Protected data source 635 may be used to generate, access, obtain, record and/or register protected data.

Buffer module 605 may also provide communication over a network 640 with a protected data server 650, which may be operated by or on behalf of a person or entity to receive from anti-tamper system 600 information relating to the protected data that may be recorded or registered by protected data source 635. Network 640 may be or include a public and/or a private wide area network and may include the Internet and or an intranet.

Signing module 610 may communicate with buffer module 605 to receive information relating to protected data that may be recorded or registered by protected data source 635 and to provide encryption of the protected data information to provide a cryptographic record of such protected data registrations. Signing module 610 may further provide to buffer module 605 cryptographic receipt information for a protected data registration, and buffer module 605 may provide the cryptographic receipt information to protected data source 635 as a confirmation. In embodiments, anti-tamper system 600 may be directed to providing tamper-proof or tamper-resistant recording of retail transactions.

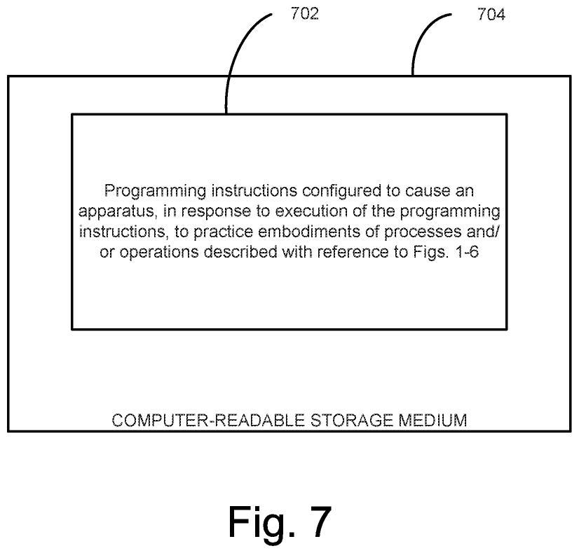

FIG. 7 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 702 may include a number of programming instructions 704. Programming instructions 704 may include instructions that are configured to enable an apparatus, e.g., apparatus 100 or 600, in response to execution of the programming instructions, to provide a FCU 100 and/or an anti-tamper system 600 that may practice process 400 or an analogous process. In embodiments, programming instructions 804 may be disposed on multiple computer-readable non-transitory storage media 802. In still other embodiments, programming instructions 804 may be disposed on computer-readable transitory storage media 802, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's wearable device, partly on the user's wearable device, as a stand-alone software package, partly on the user's wearable device and partly on a remote computer or entirely on the remote computer or server. In the latter scenario, the remote computer may be connected to the user's wearable device through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### Examples

Some non-limiting examples are provided below.

Example 1 may include a system, which may comprise: a central processor unit that may include a first processing unit and a second processing unit that may operate independently of the first processing unit, and may be isolated from the first processing unit; a buffer module that may operate within the first processing unit and that may provide communication with a fiscal control server and an electronic transaction register and wherein the buffer module may be to receive transaction registrations from the electronic transaction register; and a signing module that may be to operate within the second processing unit, to communicate with the buffer module, and to provide a cryptographic record of transaction registrations received by the buffer module.

Example 2 may include the system of example 1 wherein the signing module may further be to provide to the buffer module cryptographic receipt information for a transaction registration and the buffer module may further be to provide the cryptographic receipt information to the electronic transaction register to be included in a receipt.

Example 3 may include the system of example 1 wherein the buffer module may further be to provide secure communication to the fiscal control server of the cryptographic record provided by the signing module.

Example 4 may include the system of any of examples 1-3 wherein the first processing unit may be a primary processing unit of the central processor unit and may be to provide generalized primary processing of the central processor unit in accordance with an operating system.

Example 5 may include the system of example 4 wherein the second processing unit may not be a primary processing unit of the central processor unit and may not be to provide generalized primary processing provided by the central processor unit.

Example 6 may include the system of example 4 wherein the second processing unit may be to operate independently of the operating system.

Example 7 may include the system of any of examples 1-3 wherein the second processing unit may further provide communication independently of the first processing unit and the signing module may further be to receive initializing cryptographic information via communication of the second processing unit.

Example 8 may include the system of example 7 wherein the signing module may be to receive the initializing cryptographic information from the fiscal control server.

Example 9 may include the system of any of examples 1-3 wherein the electronic transaction register may include a transaction register module to operate within the first processing unit.

Example 10 may include the system of any of examples 1-3 wherein the first processing unit may include one or more applet drivers and the second processing unit may include a virtual machine to execute a signing module applet associated with the one or more applet drivers.

Example 11 may include a method, which may comprise: operating a buffer module of a fiscal control unit in a first processing unit of a central processor unit, wherein the buffer module may be to communicate with an electronic transaction register to receive transaction registrations from the electronic transaction register; and operating a signing module of a fiscal control unit within a second processing unit of the central processor unit, wherein the second processing unit may be to operate independently of the first processing unit and the signing module may be to communicate with the buffer module to provide a cryptographic record of transaction registrations received by the buffer module.

Example 12 may include the method of example 11 and may further include generating at the signing module cryptographic receipt information for a transaction registration and providing the cryptographic receipt information to the electronic transaction register to be included in a receipt.

Example 13 may include the method of example 11 and may further include providing secure communication to a fiscal control server of the cryptographic record provided by the signing module.

Example 14 may include the method of any of examples 11-13 wherein the first processing unit may be a primary processing unit of the central processor unit and may be to provide generalized primary processing provided by the central processor unit in accordance with an operating system, and wherein the second processing unit may be to operate independently of the operating system.

Example 15 may include the method of any of examples 11-13 may further include operating the second processing unit to obtaining initializing cryptographic information independently of the first processing unit.

Example 16 may include the method of example 15 wherein the second processing unit may be to obtain the initializing cryptographic information from a fiscal control server.

Example 17 may include the method of any of examples 11-13 and may further include operating the electronic transaction register as a transaction register module within the first processing unit.

Example 18 may include a -transitory computer-readable media, which may comprise: a first non-transitory computer-readable medium that may include instructions to cause a first processing unit of a central processor unit, in response to execution of the instructions by the first processing unit, to buffer communications with an electronic transaction register to receive transaction registrations from the electronic transaction register; and a second non-transitory computer-readable medium that may include instructions to cause a second processing unit of a central processor unit, in response to execution of the instructions by the second processing unit, to provide a cryptographic record of transaction registrations from the electronic transaction register, wherein the first and second non-transitory computer-readable media may be distinct from each other.

Example 19 may include the non-transitory computer-readable media of example 18 wherein the second non-transitory computer-readable medium may further include instructions to cause the second processing unit to generate cryptographic receipt information for a transaction registration and may provide the cryptographic receipt information to the electronic transaction register to be included in a receipt.

Example 20 may include the non-transitory computer-readable media of example 18 wherein the first non-transitory computer-readable medium may further include instructions to cause the first processing unit to communicate the cryptographic record provided by the second processing unit to a fiscal control server.

Example 21 may include the non-transitory computer-readable media of any of examples 18-20 wherein the first non-transitory computer-readable medium may further include instructions to cause the first processing unit to provide generalized primary processing of the central processor unit in accordance with an operating system, and wherein the second non-transitory computer-readable medium may further include instructions to cause the second processing unit to operate independently of the operating system.

Example 22 may include the non-transitory computer-readable media of any of examples 18-20 wherein the second non-transitory computer-readable medium may further include instructions to cause the second processing unit to receive initializing cryptographic information independently of the first processing unit.

Example 23 may include the non-transitory computer-readable media of example 22 wherein the second processing unit may be to receive the initializing cryptographic information from a fiscal control server.

Example 24 may include the non-transitory computer-readable media of any of examples 18-20 wherein the first non-transitory computer-readable medium may further include instructions to cause the first processing unit to operate the electronic transaction register within the first processing unit.

Example 25 may include a system, which may comprise: a central processor unit that may include a first processing unit and a second processing unit that may operate independently of the first processing unit, and isolated from the first processing unit; a buffer module to operate within the first processing unit to provide communication with a fiscal control server and an electronic transaction register and wherein the buffer module may be to receive transaction registrations from the electronic transaction register; and a signing module to operate within the second processing unit, to communicate with the buffer module, and to provide a cryptographic record of transaction registrations received by the buffer module.

Example 26 may include the system of example 25 wherein the signing module may further be to provide to the buffer module cryptographic receipt information for a transaction registration and the buffer module may further be to provide the cryptographic receipt information to the electronic transaction register to be included in a receipt.

Example 27 may include the system of example 25 wherein the buffer module may further provide secure communication to the fiscal control server of the cryptographic record provided by the signing module.

Example 28 may include the system of example 25 wherein the first processing unit may be a primary processing unit of the central processor unit and may be to provide generalized primary processing of the central processor unit in accordance with an operating system.

Example 29 may include the system of example 28 wherein the second processing unit may not be a primary processing unit of the central processor unit and is not to provide generalized primary processing provided by the central processor unit.

Example 30 may include the system of example 28 wherein the second processing unit may be to operate independently of the operating system.

Example 31 may include the system of example 25 wherein the second processing unit may further provide communication independently of the first processing unit and the signing module may further be to receive initializing cryptographic information via communication of the second processing unit.

Example 32 may include the system of example 31 wherein the signing module may be to receive the initializing cryptographic information from the fiscal control server.

Example 33 may include the system of example 25 wherein the electronic transaction register may include a transaction register module to operate within the first processing unit.

Example 34 may include the system of example 25 wherein the first processing unit may include one or more applet drivers and the second processing unit may include a virtual machine to execute a signing module applet associated with the one or more applet drivers.

Example 35 may include a method, which may comprise: operating a buffer module of a fiscal control unit in a first processing unit of a central processor unit, wherein the buffer module may be to communicate with an electronic transaction register to receive transaction registrations from the electronic transaction register; and operating a signing module of a fiscal control unit within a second processing unit of the central processor unit, wherein the second processing unit may be to operate independently of the first processing unit and the signing module may be to communicate with the buffer module to provide a cryptographic record of transaction registrations received by the buffer module.

Example 36 may include the method of example 35 and may further include generating at the signing module cryptographic receipt information for a transaction registration and providing the cryptographic receipt information to the electronic transaction register to be included in a receipt.

Example 37 may include the method of example 35 and may further include providing secure communication to a fiscal control server of the cryptographic record provided by the signing module.

Example 38 may include the method of example 35 wherein the first processing unit may be a primary processing unit of the central processor unit and may be to provide generalized primary processing provided by the central processor unit in accordance with an operating system, and wherein the second processing unit may be to operate independently of the operating system.

Example 39 may include the method of example 35 may further include operating the second processing unit to obtaining initializing cryptographic information independently of the first processing unit.

Example 40 may include the method of example 39 wherein the second processing unit may be to obtain the initializing cryptographic information from a fiscal control server.

Example 41 may include the method of example 35 may further include operating the electronic transaction register as a transaction register module within the first processing unit.

Example 42 may include a non-transitory computer-readable media, which may comprise: a first non-transitory computer-readable medium that may include instructions to cause a first processing unit of a central processor unit, in response to execution of the instructions by the first processing unit, to buffer communications with an electronic transaction register to receive transaction registrations from the electronic transaction register; and a second non-transitory computer-readable medium that may include instructions to cause a second processing unit of a central processor unit, in response to execution of the instructions by the second processing unit, to provide a cryptographic record of transaction registrations from the electronic transaction register, wherein the first and second non-transitory computer-readable media may be distinct from each other.

Example 43 may include the non-transitory computer-readable media of example 42 wherein the second non-transitory computer-readable medium may further include instructions that may cause the second processing unit to generate cryptographic receipt information for a transaction registration and that may provide the cryptographic receipt information to the electronic transaction register to be included in a receipt.

Example 44 may include the non-transitory computer-readable media of example 42 wherein the first non-transitory computer-readable medium may further include instructions that may cause the first processing unit to communicate the cryptographic record provided by the second processing unit to a fiscal control server.

Example 45 may include the non-transitory computer-readable media of example 42 wherein the first non-transitory computer-readable medium may further include instructions to cause the first processing unit to provide generalized primary processing of the central processor unit in accordance with an operating system, and wherein the second non-transitory computer-readable medium may further include instructions to cause the second processing unit to operate independently of the operating system.

Example 46 may include the non-transitory computer-readable media of example 42 wherein the second non-transitory computer-readable medium may further include instructions to cause the second processing unit to receive initializing cryptographic information independently of the first processing unit.

Example 47 may include the non-transitory computer-readable media of example 46 wherein the second processing unit may be to receive the initializing cryptographic information from a fiscal control server.

Example 48 may include the non-transitory computer-readable media of example 42 wherein the first non-transitory computer-readable medium may further include instructions to cause the first processing unit to operate the electronic transaction register within the first processing unit.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A system, comprising:
a central processor unit that includes a first processing unit and a second processing unit that operates independently of the first processing unit, and isolated from the first processing unit;
a buffer module to operate within the first processing unit to provide communication with a protected data server and a protected data source and wherein the buffer module is to receive data registrations from the protected data source; and
a signing module to operate within the second processing unit, to communicate with the buffer module, and to provide a cryptographic record of data registrations received by the buffer module.

2. The system of claim 1 wherein the signing module is further to provide to the buffer module cryptographic receipt information for a data registration and the buffer module is further to provide the cryptographic receipt information to the protected data source to be included in a receipt.

3. The system of claim 1 wherein the buffer module is further to provide secure communication to the protected data server of the cryptographic record provided by the signing module.

4. The system of claim 1 wherein the first processing unit is a primary processing unit of the central processor unit and is to provide generalized primary processing of the central processor unit in accordance with an operating system.

5. The system of claim 4 wherein the second processing unit is not a primary processing unit of the central processor unit and is not to provide generalized primary processing provided by the central processor unit.

6. The system of claim 4 wherein the second processing unit is to operate independently of the operating system.

7. The system of claim 1 wherein the second processing unit further provides communication independently of the first processing unit and the signing module is further to receive initializing cryptographic information via communication of the second processing unit.

8. The system of claim 7 wherein the signing module is to receive the initializing cryptographic information from the protected data server.

9. The system of claim 1 wherein protected data source includes a transaction register module to operate within the first processing unit.

10. The system of claim 1 wherein the first processing unit includes one or more applet drivers and the second processing unit includes a virtual machine to execute a signing module applet associated with the one or more applet drivers.

11. A method, comprising:
operating a buffer module of a fiscal control unit in a first processing unit of a central processor unit, wherein the buffer module is to communicate with an electronic transaction register to receive transaction registrations from the electronic transaction register; and
operating a signing module of a fiscal control unit within a second processing unit of the central processor unit, wherein the second processing unit is to operate independently of the first processing unit and the signing module is to communicate with the buffer module to provide a cryptographic record of transaction registrations received by the buffer module.

12. The method of claim 11 further to include generating at the signing module cryptographic receipt information for a transaction registration and providing the cryptographic receipt information to the electronic transaction register to be included in a receipt.

13. The method of claim 11 further to include providing secure communication to a fiscal control server of the cryptographic record provided by the signing module.

14. The method of claim 11 wherein the first processing unit is a primary processing unit of the central processor unit and is to provide generalized primary processing provided by the central processor unit in accordance with an operating system, and wherein the second processing unit is to operate independently of the operating system.

15. The method of claim 11 further to include operating the second processing unit to obtaining initializing cryptographic information independently of the first processing unit.

16. The method of claim 15 wherein the second processing unit is to obtain the initializing cryptographic information from a fiscal control server.

17. The method of claim 11 further to include operating the electronic transaction register as a transaction register module within the first processing unit.

18. Non-transitory computer-readable media, comprising:
a first non-transitory computer-readable medium including instructions to cause a first processing unit of a central processor unit, in response to execution of the instructions by the first processing unit, to buffer communications with an electronic transaction register to receive transaction registrations from the electronic transaction register; and
a second non-transitory computer-readable medium including instructions to cause a second processing unit of a central processor unit, in response to execution of the instructions by the second processing unit, to provide a cryptographic record of transaction registrations from the electronic transaction register,
wherein the first and second non-transitory computer-readable media are distinct from each other.

19. The non-transitory computer-readable media of claim 18 wherein the second non-transitory computer-readable medium further includes instructions to cause the second processing unit to generate cryptographic receipt information for a transaction registration and to provide the cryptographic receipt information to the electronic transaction register to be included in a receipt.

20. The non-transitory computer-readable media of claim 18 wherein the first non-transitory computer-readable medium further includes instructions to cause the first processing unit to communicate the cryptographic record provided by the second processing unit to a fiscal control server.

21. The non-transitory computer-readable media of claim 18 wherein the first non-transitory computer-readable medium further includes instructions to cause the first processing unit to provide generalized primary processing of the central processor unit in accordance with an operating system, and wherein the second non-transitory computer-readable medium further includes instructions to cause the second processing unit to operate independently of the operating system.

22. The non-transitory computer-readable media of claim 18 wherein the second non-transitory computer-readable medium further includes instructions to cause the second processing unit to receive initializing cryptographic information independently of the first processing unit.

23. The non-transitory computer-readable media of claim 22 wherein the second processing unit is to receive the initializing cryptographic information from a fiscal control server.

24. The non-transitory computer-readable media of claim 18 wherein the first non-transitory computer-readable medium further includes instructions to cause the first processing unit to operate the electronic transaction register within the first processing unit.
